(19) United States
(12) Patent Application Publication
(10) Pub. No.: US 2009/0287615 A1
(43) Pub. Date: Nov. 19, 2009

(54) Forward-Looking Expense Allocation (FLEA)

(76) Inventor: Richard St. Rose, San Diego, CA (US)

Correspondence Address: John Karl Buche;BUCHE & ASSOCIATES, P.C., 875 PROSPECT, SUITE 305, LA JOLLA, CA, 92037, US

(21) Appl. No.: 12/119,494

(22) Filed: May 13, 2008

(51) Int. Cl. G06Q 90/00

(52) U.S. Cl. 705/500

(57) ABSTRACT

A method for managing a real-estate investment comprising the steps of employing a method for identifying a suitable investment property; identifying at least one operating expense associated with the ownership of said property and projecting the total cost of said operating expense over a period of time; securing capital, in an amount which is at least partially based on said total cost of said operating expense that was projected over said period of time; acquiring at least a fraction of said property; using at least a portion of said capital to pay at least a part of said operating expense over said period of time, as said operating expense becomes due; and, transferring said fraction of said property for value.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention

The following application is in the field of business methods. More specifically, the following is in the field of business methods for the management of investment properties and/or the field of business methods for investing in property.

2. Background of the Invention

Generally, and depending on available funds, would-be real estate investors often must choose between: (1) investing in high capitalization rate markets (those markets that are less desirable with lower property values than other markets relative to net income) to reap high cash-flows (a larger share of property income is cash to the investor, but the investor sees little increase in overall equity); or (2) investing in low capitalization rate markets (those markets that are more desirable with higher property values than other markets relative to net income) for high internal rates of return (each dollar invested in the property grows as equity at a faster rate, but the investor sees little cash flow over the holding period). The decision is particularly important when the investment requires a predetermined holding period (i.e., the period of time between acquisition and sale of the investment property). For obvious reasons, the investor often prefers an optimal level of high cash-flow and high internal return rates.

Various costs are associated with holding property through a holding period, and these costs will diminish the investor's cash-flow. For example, interest owed on financing and property operating expenses can reduce property income, resulting in reduced cash-flow. Also, the tax advantages to the investor associated with deductions on interest payments and operating expenses are experienced over the holding period, because such are paid periodically over-time; investors often would rather realize these tax advantages up front.

To date, various business methods aimed at increasing cash-flows and internal rates of return over the property holding period have focused only on the interest owed to financing, whereby a real-estate investor will buy-down the interest rate with an up-front interest payment to produce a larger cash-flow position over the holding period. However, because of the uncertainties and risks associated with property operating costs over a holding period, business methods have not addressed these costs as a solution to the investor's cash-flow v. internal rate of return dilemma.

Real-estate investment managers often incorporate several real estate services (i.e., brokerage, property management, syndication, etc.) into one product to create an entirely passive real estate investment. For example, investment managers may suggest investment properties and acquire the investor's desired property, supervise it, and sell it after the holding period. For their services, investment managers are usually paid a commission. The larger the deal, the larger the commission; the more frequently deals are made, the more frequently commissions are received. The aforementioned investor's choice, between high and low capitalization rate markets, defeats many deals that might otherwise be available to the investment manager, because, over the holding period, either the projected cash-flow is insufficient or the projected internal return rates are too low. Moreover, since investment managers' commissions are paid for services, there are currently no suitable means for the investor to allocate certain risks associated with the property holding to the investment manager. Conversely, there are not suitable means for the investment manager to profit from risks associated with holding the property.

### SUMMARY OF THE INVENTION

Accordingly, it is an object of the present invention to provide a business method for managing real-estate investments and a business method for investing in real-estate which provide the optimal level of high cash-flow and high internal rates of return to the investor. Often, the optimal level is where the investor achieves both cash flow and internal rate of return objectives simultaneously.

It is another object of the present invention to provide a business method for managing real-estate investments and a business method for investing in real-estate which targets the property operating costs as an avenue for resolving the investor's dilemma, and which result in positive tax consequences to the investor.

It is yet another object of the present invention to provide a business method for managing real-estate investments and a business method for investing in real-estate whereby investment managers complete a larger number of deals which would otherwise go uncompleted due to cash-flow and internal return rate concerns. Along these same lines, it is an object of the present invention to provide a method, whereby an investor who borrows the investment capital (even at higher interest rates) may achieve both cash flow and internal rate of return objectives simultaneously.

A further object of the present invention is to provide a business method for managing real-estate investments and a business method for investing in real-estate whereby a portion of the risk and uncertainty associated with a property holding is allocated from the investor to the investment manager.

### BRIEF DESCRIPTION OF THE FIGURES

Other objectives of the method will become apparent to those skilled in the art once the method has been shown and described. The manner in which these objectives and other desirable characteristics can be obtained is explained in the following description and attached figures in which:

FIG. 1A is an exemplary identification of a property which is the subject of FIGS. 1A-1G.

FIG. 1B illustrates the calculation of total annual operating expenses of a hypothetical exemplary investment property where the business methods are applied.

FIG. 1C illustrates an exemplary calculation of the necessary acquisition capital in conjunction with the business methods.

FIG. 1E illustrates the calculation of the total Forward-Looking Expense Allocation (hereinafter “FLEA”) expense.

FIG. 1F illustrates the calculation of a hypothetical total required investment.

FIG. 1G is a cash-flow comparison of the classical real-estate investment method versus the FLEA method.

FIG. 1H is a cash-on-cash rate comparison between the classical real-estate investment method versus the FLEA method.

FIG. 1I is an internal rate of return comparison between the classical real-estate investment method versus the FLEA method.

FIG. 2 is a general flow chart of the FLEA method.

FIG. 3 is a general flow chart of the classical real estate investment method.

### DETAILED DESCRIPTION OF PREFERRED METHODS

In general, the Forward-Looking Expense Allocation Method (hereinafter “the FLEA Method” or “the Method”) represents a method for managing real-estate investments and/or a method for investing in real-estate wherein operating expenses are targeted by the investor as an avenue for attaining relatively higher levels of cash flow for any given initial investment amount while still maintaining high internal rates of return on the real estate in lower capitalization rate markets. A real-estate investor may use the FLEA Method, but when an entirely passive real-estate investment is desired by the investor, the FLEA Method is used by a real-estate investment manager; either way, the Method is performed by completing the steps presented below and illustrated by the figures.

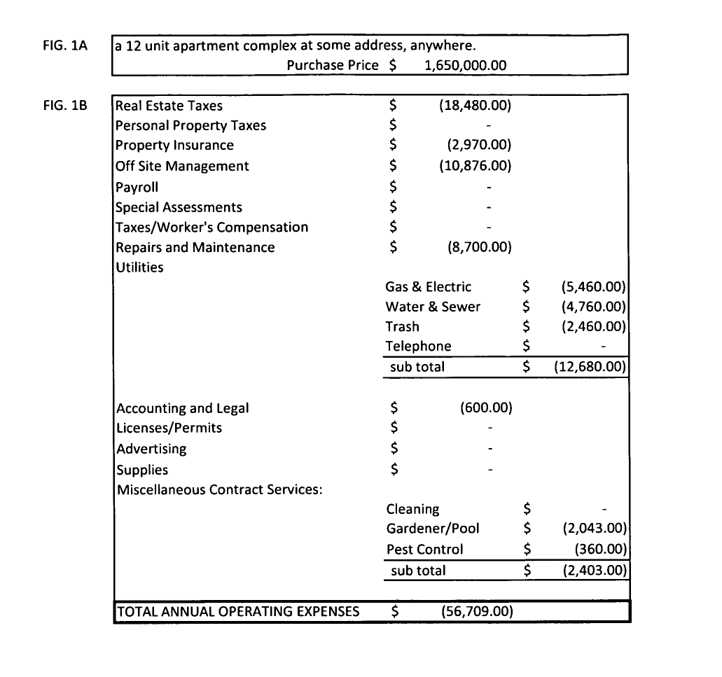

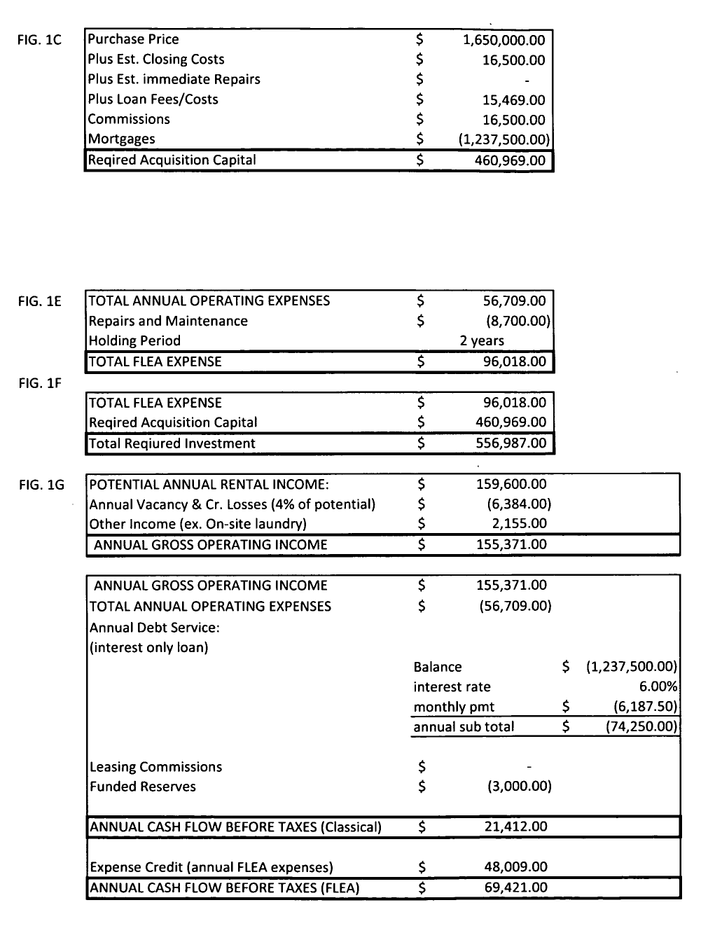

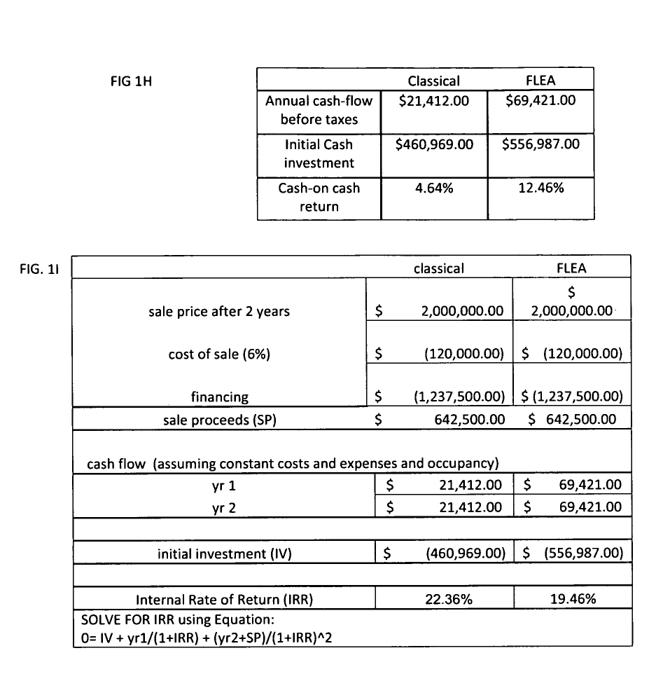

At some point, a suitable investment property is identified. The many methods and modes by which an investment property might be identified are, in some cases, complex, random, unexpected, and/or idiosyncratic; such methods and modes are readily apparent to one skilled in the art of real-estate investments. Subject thereto, properties are generally identified by examining property listings and attempting to ascertain whether a particular listing has potential to produce cash income and/or increases in value. FIG. 1A represents an exemplary model for application of the methods described herein. FIG. 1A represents a typical twelve unit apartment complex, at a certain address, which was identified by an investor or investment manager through a commercial listing. The purchase price for this particular property is $1,650,000.00.

After a property has been identified, the property's expected operating expenses are determined and an expected annual budget created. Generally, operating expenses for investment properties include property taxes, insurance, administrative fees, repairs/maintenance, utilities, and miscellaneous contract services. Typically, the operating expenses vary in cash amounts depending on certain factors including, but not limited to, the following: property size; property age; property location; and, property condition. Often, operating expense values are determined by data from the previous owner, data from comparable properties in the area, or data from the individual or service which might be responsible for the expense, but the exact manner in which operating expense values are determined will be readily apparent to one skilled in the art of real-estate investments. An annual budget is created by projecting the operating expenses over a twelve month period and totaling all expenses. FIG. 1B represents an annual operating expense budget associated with the property identified in FIG. 1A, wherein the data was supplied by the sellers, the utility providers, or past experience. As shown in the figure, the net annual operating expenses (the sum of all annual operating expenses) for this particular property is equal to $56,709.00.

The necessary acquisition capital and optimal holding period are also determined after the property has been identified. As the title implies, the necessary acquisition capital is the amount of money the investor must provide in order to acquire the identified property. Its value is determined by subtracting from the purchase price any financing for the acquisition, and by an addition thereto of any associated transactional costs, any acquisition fees, and the cost of any immediate repairs. The specific costs, fees and repairs for a particular property will depend on the specifics of the property and other arrangements between investor, seller, and third parties, and a person skilled in the art of real-estate investments will know the type, nature, and character of any such fees and expenditures. FIG. 1C illustrates the calculation of the necessary acquisition capital for the property of FIGS. 1A and 1B. In this particular instance, the closing costs of the sale, the financing fees, and the commissions were added to the purchase price of the property to represent the total of funds which must change hands before the property does; the mortgage is then subtracted therefrom because it represents moneys which are not out-of-pocket to the investor. The necessary acquisition capital, which must be fronted by the investor, in this case is $460,969.00.

The holding period for the investment is the period of time between acquisition and sale of the investment property by the investor. The optimal holding period for the investment represents the duration in which the highest rate of return is realized on the initial investment. It is determined by projecting and plotting the rate of return over several different holding periods and selecting the period which results in the largest. Also, a holding period may be determined by the amount of time an investor wants his capital tied to the investment. In the present example, the optimal holding period is determined two years.

To perform the FLEA method, the FLEA expenses are identified, selected, projected over the holding period, and totaled. FLEA expenses consist of all projected expenses to be incurred in the normal operation of the investment property except repairs, maintenance, and funded reserves for capital improvements. The exact FLEA expenses depend on the specifics and requirements of the subject property, but are generally any expenses that are not maintenance or repair related and which are readily quantifiable. A person skilled in the art of real estate investment will readily identify such expenses for a given property, and subject thereto, a non-exclusive list of such expenses includes real estate taxes, personal property taxes, property insurance, off site management, payroll, special assessments, taxes, worker's compensation, gas, electric, water, sewer, trash removal, telephone, accounting, legal fees, licenses, permits, advertising, supplies, miscellaneous contract services, cleaning, gardening, pool maintenance, and pest control. It should be noted that interest and other mortgage/financing service fees are not FLEA expenses because they are not part of the operation of the property. Once the FLEA expenses are identified, some or all of the FLEA expenses may be selected and projected over the property holding period (the period between the anticipated acquisition date and the projected sales date), taking into account any anticipated escalation or de-escalation of these expenses The total FLEA expense represents the expected operating expenses of the property (excluding repair, maintenance, and funded reserves for capital improvements) over the life of the investment, and it is determined by totaling the selected and projected FLEA expenses and multiplying by the holding period. FIG. 1E illustrates the calculation of the total FLEA expense for the property identified by FIG. 1A. In the present case, the selected FLEA expenses are all annual operating expenses shown in FIG. 1B except repair and maintenance which results in a total FLEA expense of $48,009.00.

After the total FLEA expense (see FIG. 1E) and the necessary acquisition capital (see FIG. 1C) have been determined, the total required investment is calculated by adding the two figures together. The total required investment represents the up-front, out-of-pocket moneys to be provided by the investor. In the classic real-estate investment, FLEA expenses are not paid up front; rather, the actual operating expenses are paid as they are incurred or periodically. The result of paying these expenses in the classical manner (periodically over time) is a lower cash-flow as the expenses are paid, and assumption of the entire risk associated with the operating expenses by the investor. On the other hand, paying the total FLEA expense up front increases cash-flow relative to each dollar invested as fewer and lower periodic payments for the various expenses are made by the investor. In the context of a passive real-estate investment via a real-estate investment manager, paying the total FLEA up front to the investment manager transfers the risk of faulty expense predictions, unexpected expenses, and so forth. In other words, the investment manager guarantees the selected FLEA expenses, and is financially responsible for any overruns. Accordingly, the risk to the investor is reduced because variable expenses, subject to budget overruns, are translated into a fixed up front cost, and any additional costs associated with budget overruns are borne by the investment manager. As discussed below, the total FLEA is deposited in the investment manager's operational account, wherein the expenses are paid out as they accrue (all non-FLEA expenses are paid out of the property income). The FLEA provides an incentive to the investment manager to efficiently operate the investment property because any remaining money in the account after the holding period (i.e., the FLEA expenses were less than previously anticipated) is assumed by the investment manager. In addition to commissions paid for services, the FLEA account also represents additional compensation to the investment manager who, by virtue of having the money up front and paying for FLEA expenses over time, retains the time-value benefit of the funds in the account. This aforementioned assumption of risk by the investment manager justifies the exclusion of funded reserves for capital improvements from FLEA expenses because, if included, the investor could essentially rebuild the entire building and bill the investment manager. Likewise, for the repair and maintenance exclusions, which are barely differentiable from funded reserves by subjective and ambiguous rationales. FIG. 1F illustrates the calculation of the total required investment to be fronted by the investor, assuming there is no expected escalation in any of the selected FLEA expenses. The total FLEA expense (see FIG. 1E) is added to the necessary acquisition capital (see FIG. 1C) to equal, $556,987.

When ready, a commitment of capital, equaling the total required investment, must be obtained from the investor. The committed capital may be provided by the investor out of personal funds, or because of the relatively high cash-flows generated by the FLEA Method, the capital may be financed (even if at a high interest rate) by a lender with the financing costs paid using investment income. Accordingly, the FLEA Method creates real-estate investment opportunities for individuals who lack the sufficient excess capital necessary to cover the total required investment, since cash-flows produced by the Method are typically sufficient to cover the costs associated with borrowing such funds.

FIG. 1G compares the cash-flows generated by a classical real-estate investment in the property identified by FIG. 1A against those generated by the FLEA method. The twelve apartment units on the property are rented at market value, have a vacancy rate of 4%, and create an alternate income source in the form of an on-site Laundromat, resulting in an annual gross operating income of $155,371.00. To get the cash-flow associated with the classical investment method, the FLEA expenses, and non-FLEA expenses are subtracted from the annual gross operating income to produce a cash-flow of $21,412.00 before taxes. Unlike the classical investment method, in the FLEA Method, the annual FLEA expenses are paid out of the expense account containing the total FLEA expense rather than the property income. Accordingly, the much higher cash-flow before taxes is $69,421.00. In addition to the relatively higher cash-flow, the investor realizes additional internal rates of return through appreciation of the property when the property is sold after the holding period.

As mentioned previously, the FLEA method normally produces higher cash flows per initial cash investment. To illustrate, FIG. 1H is a cash-on-cash returns comparison of the classical and the FLEA investment methods. The Annual Cash-flow Before Taxes for both the classical and FLEA are set forth in FIG. 1G, and the initial investment cash for each method is the Required Acquisition Price (FIG. 1C) and the Total Required Investment (FIG. 1F) respectively. As set forth in the figure, the classical method produces a 4.64% cash-on-cash return, while the FLEA method produces a 12.46% return.

Though the classical method normally produces slightly higher internal rates of return than the FLEA real-estate investment method, the reduction in internal rate of return is generally minimal and represents a modest trade off for the extremely higher levels of cash flow associated with the FLEA method. FIG. 1I is a comparison of the internal rates of return before taxes for the two methods assuming a sale price of $2,000,000.00 after the two-year holding period, fixed costs and expense over the holding period, and constant occupancy. After paying out the initial costs, collecting the annual cash-flow in year 1 and year 2, and collecting the net proceeds of the sale in year 2, the internal rates of return are 22.36% for the classical method, and 19.46% for the FLEA.

If the investor is a group of individuals, each contributor will retain pro-rata ownership of the property based on the ratio between the individual commitments and the total required investment. In the case of a group investment, syndication agreements are entered, syndication fees are charged (normally at a rate of 0.5%-1% of the difference between the individuals commitment and the total required investment), and a tenants-in-common agreement is entered into by the contributors which spells out how any contingencies will be addressed throughout the holding period. Syndication fees are not included for purposes of calculating ownership percentages, but any banking or syndication fees are added to the total required investment to represent the total capital fronted by the investor. These funds are suitably collected, usually in a trust account, before contracting to purchase the property, or else an investor's unanticipated shortage of funds could cause the transaction to go awry.

At any point after a property has been identified as a suitable real-estate investment the following typically occurs: an offer is made to purchase the property (preferably consistent with projected prices); a purchase contract is entered into by the seller and the investor; the signed purchase contract and the required acquisition capital (from the trust account) are forwarded to escrow; financing in the form of a mortgage (or equivalent) is secured; and due diligence inspections are performed to assess whether the transaction should move forward. If the investor is a group, the larger contributors in the syndication typically apply for the mortgage to purchase the property and enter the purchase contract (a fractional ownership grant deed might be necessary to distribute the ownership to those contributors not involved in the financing of the property). Careful attention must be paid to the method of financing the purchase, because the loan product must be selected that will be consistent with the internal rate of return and the cash flow objectives of the investor.

If, after a contract is forwarded to escrow, additional capital is required because the total required investment was partially based on projections, then it will be necessary to obtain that commitment by assigning all or a portion of the existing investor's position within the transaction to the new investors. A contingency such as this should be provided for in the applicable contracting instrument. Relatedly, once the preliminary closing statements are received from escrow, the actual total required investment may change based on the information therein. Accordingly, the information should be used to adjust the total required investment and to establish any ownership percentages. With the actual required investment calculated, the tenants-in-common agreement should be finalized. In the context of a real-estate investment via an investment manager, a FLEA property agreement, which specifies the total FLEA expense and which FLEA expenses have been selected as the responsibility of the manager, should be signed by the investor.

After the required acquisition capital has been transferred from the trust account to escrow and the transaction has closed, the remaining funds that are allocated to the total FLEA expense are moved into an operational account whereby they are used in the manner described above (i.e., pay FLEA expenses as they become due). All cash-flows are allocated and distributed to the contributors according to their ownership percentage.

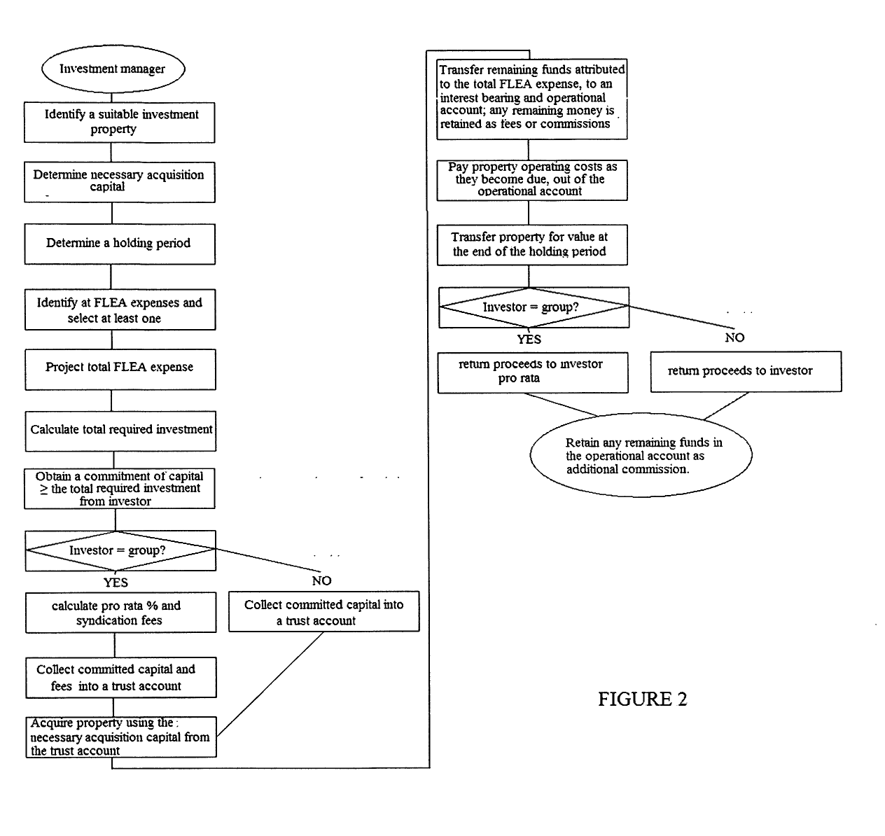

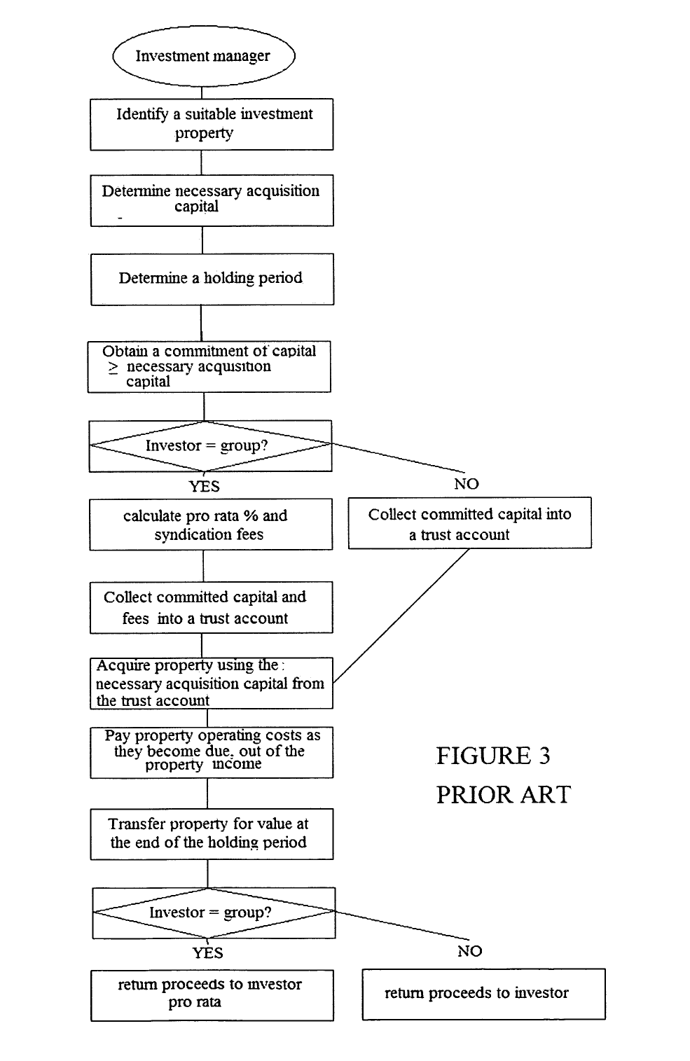

Finally, as the holding period nears completion (between about zero and six months or so from the end) the property should be listed and marketed for sale. If the investor is a group, a signed listing agreement is required from all contributors. The property is sold in the ordinary course and in due time. FIG. 2 is a flow chart for the FLEA method and illustrates generally the steps identified above. FIG. 3 is a flow chart for the classical method for investing in real estate. FIGS. 2 and 3 can be compared to illustrate the differences between the classical and FLEA methods.

In addition to the relatively high cash-flow production to the investor, the additional compensation provided to the investment manager, and transfer of risk mentioned above, the FLEA Method has other advantages. First, the FLEA method is compatible with real-estate investments which require fractional ownership. Second, tax advantages result from the FLEA method: the FLEA method creates another variable that can be adjusted to meet internal revenue code 1031 exchange requirements; and, the FLEA method allows investors to deduct up front the majority of the expenses that will be paid on the subject property that would otherwise be deducted across the entire holding period. Third, the acronym F-L-E-A is contextually compatible with other acronyms employed in the industry, both functionally and mnemonically (i.e., T-I-C for Tenants-in-common). Finally, the FLEA method allows the investment manager to effectively lock the investor into a long-term, prepaid contract since a large sum of money is provided to the investment manager. This long-term, prepaid arrangement provides financial security to what would otherwise be a variable income stream for property management services.

In summary, the present method generally a method for managing a real-estate investment comprising the steps of employing a method for identifying a suitable investment property; identifying at least one operating expense associated with the ownership of said property and projecting the total cost of said operating expense over a period of time; securing capital, in an amount which is at least partially based on said total cost of said operating expense that was projected over said period of time; acquiring at least a fraction of said property; using at least a portion of said capital to pay at least a part of said operating expense over said period of time, as said operating expense becomes due; and, transferring said fraction of said property for value.

I claim:

1. A method for managing a real-estate investment comprising the steps of:
employing a method for identifying a suitable investment property;
identifying at least one operating expense associated with the ownership of said property and projecting the total cost of said operating expense over a period of time;
securing capital, in an amount which is at least partially based on said total cost of said operating expense that was projected over said period of time;
acquiring at least a fraction of said property;
using at least a portion of said capital to pay at least a part of said operating expense over said period of time, as said operating expense becomes due; and,
transferring said fraction of said property for value.

2. The method of claim 1 further comprising the step of keeping as compensation the excess of said collected capital over said portion of said collected capital used to pay said part of said operating expense over said period of time.

3. The method of claim 1 further comprising the step of placing said collected capital in an interest bearing venture until said portion of said collected capital is withdrawn from said venture to pay said part of said operating expense over said period of time.

4. The method of claim 1 wherein said operating expense is not repair or maintenance related.

5. The method of claim 1 wherein said operating expense is not funded reserves for capital improvements.

6. The method of claim 1 wherein said period of time is the optimal holding period, and where the method further comprises the step of employing a method of determining the optimal holding period.

7. The method of claim 1 wherein said operating expense is identified in the group consisting of real estate taxes, personal property taxes, property insurance, off site management, payroll, special assessments, taxes, worker's compensation, gas, electric, water, sewer, trash removal, telephone, accounting, legal fees, licenses, permits, advertising, supplies, miscellaneous contract services, cleaning, gardening, pool maintenance, and pest control.

8. The method of claim 1 wherein said amount of said collected capital is greater than or equal to said total cost of said operating expense projected over said period of time.

9. The method of claim 1 further comprising the following steps:
obtaining a capital commitment for said secured capital from at least once source; and,
employing a method for determining cash-flows over said holding period and forwarding at least a portion of said cash-flows to said source of said secured capital.

10. A method for real-estate investment comprising the steps of:
employing a method for identifying a suitable investment property;
determining the necessary acquisition capital for said property;
determining a holding period;
identifying a plurality of FLEA expenses and selecting at least one of said FLEA expenses;
determining the total FLEA expense associated with said selected FLEA expense;
securing capital, in an amount which is at least as much as the sum of said total FLEA expense and said necessary acquisition capital;
acquiring at least a fraction of said property with a first portion of said capital which equals said necessary acquisition capital;
using a second portion of said capital to pay said selected FLEA expense over the holding period, as said selected FLEA expense becomes due; and,
transferring said acquired fraction of said property for value after said holding period.

11. The method of claim 10 further comprising the step of keeping as income the excess of said capital over the sum of said first and second portion of said capital.

12. The method of claim 10 further comprising the step of placing said capital in an interest bearing venture until said capital is withdrawn from said venture to pay said part of said operating expense over said period of time.

13. The method of claim 10 wherein said total FLEA expense is based on data from the seller of said property.

14. The method of claim 10 wherein said FLEA expense readily quantifiable.

15. The method of claim 10 wherein said holding period is the optimal holding period, and where the method further comprises the step of employing a method of determining the optimal holding period.

16. The method of claim 10 wherein said FLEA expense is selected from the group consisting of real estate taxes, personal property taxes, property insurance, off site management, payroll, special assessments, taxes, worker's compensation, gas, electric, water, sewer, trash removal, telephone, accounting, legal fees, licenses, permits, advertising, supplies, miscellaneous contract services, cleaning, gardening, pool maintenance, and pest control.

17. The method of claim 1 wherein said amount of said capital is greater than the sum of said total FLEA expense and necessary acquisition capital.

18. The method of claim 10 further comprising the step of contracting with a guarantor such that if said second portion of said capital, is insufficient to pay in full, said FLEA expense as said FLEA expense becomes due, then said insufficiency is the responsibility of said guarantor.

19. The method of claim 10 further comprising the following steps:
obtaining a capital commitment for said secured capital from at least once source; and,
employing a method for determining cash-flows over said holding period and forwarding at least a portion of said cash-flows to said source of said secured capital.

20. A method for managing a real-estate investment comprising the steps of:
employing a method for identifying a suitable investment property;
determining the necessary acquisition capital for said property;
determining a holding period;
identifying a plurality of FLEA expenses and selecting at least one of said FLEA expenses;
determining the total FLEA expense associated with said selected FLEA expense;
obtaining a capital commitment from at least one source wherein said commitment is for an amount which is at least as much as the sum of said total FLEA expense and said necessary acquisition capital;
securing said committed capital;
acquiring at least a fraction of said property with a first portion of said secured capital which equals said necessary acquisition capital;
placing a second portion of said secured capital in an operable account, wherein said second portion represents the remainder of said secured capital over said first portion;
paying out of said second portion, said selected FLEA as said selected FLEA expense becomes due over the holding period;
employing a method for determining cash-flows over said holding period and forwarding at least a portion of said cash-flows to said source of said secured capital;
transferring said acquired fraction of said property for value after said holding period; and,
keeping as income the balance of said operable account.
